(19) United States
(12) Patent Application Publication
(10) Pub. No.: US 2024/0017906 A1
(43) Pub. Date: Jan. 18, 2024

(54) A GAS-PERMEABLE ELEMENT AND A METHOD OF MANUFACTURING THE SAME

(71) Applicant: AIRNOV, INC., WILMINGTON, NEW CASTLE, DE (US)

(72) Inventors: Mark Florez, Los Lunas, NM (US); Valere Logel, Levallois Perret (FR)

(21) Appl. No.: 18/258,424

(22) PCT Filed: Dec. 29, 2021
(86) PCT No.: PCT/EP2021/087785

§ 371 Date: Jun. 20, 2023

(30) Foreign Application Priority Data
Dec. 29, 2020 (EP) 20217568.3

(51) Int. Cl. B65D 81/26; B65D 51/16; B01J 20/28; B01J 20/30

(52) U.S. Cl. CPC B65D 81/264; B65D 51/1611; B65D 51/1616; B65D 81/267; B01J 20/28028; B01J 20/2805; B01J 20/28004; B01J 20/3007; B01J 20/3042; B65D 2205/02

(57) ABSTRACT

This disclosure includes a gas-permeable element formed or at least partially placed in a packaging or medical device containing sensitive or odorous products for regulating an atmosphere in the packaging or medical device. The gas-permeable element includes an active structure formed from a mixture including particles of an active material, and a fibrillated polymer as a binder. The fibrillated polymer is a polymer to which shear has been applied which holds the active material by entanglement. The gas-permeable element includes a molded thermoplastic gas-permeable envelope surrounding the active structure in fluid communication with the atmosphere of the packaging or medical device in which the gas-permeable element is placed. Also disclosed is a method of manufacture of the gas-permeable element.

### TECHNICAL FIELD

The present disclosure relates to a gas-permeable element, such as a canister, a stopper, or a compartment, for being formed or at least partially placed in a packaging or medical device filled with sensitive and/or odorous products and for regulating an atmosphere in the packaging or medical device.

Such gas-permeable elements may be used, for example, in a packaging filled with sensitive products such as food, nutraceutical products, pharmaceutical products or diagnostic products, or a compartment defined in a medical device, notably in an inhaler such as a DPI (Dry Powder Inhaler) or in a diagnostic test cartridge.

This disclosure also relates to a packaging or medical device comprising a gas-permeable element, and to a method of manufacturing a gas-permeable element.

### TECHNICAL BACKGROUND

It has become known to provide small canisters (e.g., desiccant canisters) with an active material inside and with holes that allow air exchange between an atmosphere outside of the canister and the inside comprising the active material. Such canisters are placed in a packaging or, e.g., in a medical device, in order to regulate the atmosphere in the packaging or medical device. Such canisters may, e.g., contain a desiccant material which adsorbs moisture from the air. To allow for air exchange, a canister is provided with perforations in an outside wall (e.g., in an end cap).

Moreover, it is known to provide carbon powder/granular carbon in a canister in order to prevent odors, etc.

Known canisters typically comprise a one piece plastic body containing a cylindrical outer wall and a circular bottom wall, onto which is secured a cap. Perforations for air exchange may, e.g., be provided in the cap.

Using such canisters, sensitive and/or odorous products accommodated in a packaging or a medical device may thus be protected against humidity moisture and/or the development of odors in or even outside of the packaging or medical device may be prevented, thereby improving user/customer convenience.

A disadvantage of the existing technology is that a packaging or a medical device (and thus also a product provided therein) may get contaminated with the desiccant material or, e.g., with particles such as carbon powder particles, if such particles escape from the gas-permeable element, e.g., due to dusting. In some cases, the quality of the goods may thereby even be compromised. In any case, it is unappealing for users to observe a contaminated appearance of the products, irrespective of whether the quality of the goods is compromised by the optical contamination or not.

It has been proposed to cover the holes in a canister with a breathable film or to form an envelope made of breathable film that covers the hole. However, this implies additional processing complexity (e.g., welding the breathable film) and it restricts the freedom of choice in terms of shape of the canisters.

There is, hence, a need for improvements to packaging and/or medical devices which address at least one of the above-mentioned shortcomings.

### SUMMARY

One aspect of the present disclosure relates to a gas-permeable element for being formed or at least partially (optionally, for some embodiments: fully) placed in a packaging or medical device filled with sensitive and/or odorous products, and for regulating an atmosphere in the packaging or medical device.

The gas-permeable element may, e.g., be a canister for being placed in a packaging or a medical device. The canister may be a drop-in style component that is to be placed in a packing or a medical device. In other words, if the gas-permeable element is a canister, it may typically be placed as a whole (e.g., fully positioned) in the packaging or the medical device. A canister may have a rigid construction and may promote high-speed insertion.

The gas-permeable element may, e.g., be a stopper for closing a packaging/container (such as a tube). Thereby, the stopper is partially placed in the packaging (as a part of the stopper is exposed to the inside of the packaging. The stopper may be used to close off a container, such as a tube (e.g., a plastic tube) or some other packaging or medical device. Some embodiments of the stoppers may be tamper-evident, spiral, half-spiral, easy-opening, flip-top, and/or provide a tight seal function. The stopper is typically configured to be partially placed inside the packaging or the medical device, as it may close-off the packaging or the medical device (or a part thereof), but also be at least partially exposed towards an inside of the packaging or medical device (such that an air exchange between a substance in the stopper and the inside atmosphere of the packaging or medical device takes place).

The gas-permeable element may, e.g., be a compartment of a packaging or a medical device.

As the gas-permeable element is configured to regulate an atmosphere in the packaging or medical device, the gas-permeable element may be used to add a property to the packaging or medical device. The gas-permeable element may remove/emit humidity, odor, oxygen, moisture, fragrance, or one or several other gases/fluids from/to a headspace with which there is fluid exchange (so that the active structure can exert its atmosphere regulating property).

Some embodiments of the gas-permeable element may be used as a later add-on to existing packaging and/or medical devices.

The gas-permeable element may, hence, be formed or (partially or fully) placed in a closed (finite) headspace that may be substantially isolated from external environmental conditions. An example is a moisture adsorbing canister placed in a plastic bottle that is substantially moisture tight (as reflected by the corresponding Water Vapor Transmission Rate (WVTR) value).

Some embodiments of the gas-permeable element may, prior to being placed on or in a packaging or a medical device, be kept in a (partially or fully) gas impermeable packaging for preserving its full (e.g., at least 90%, 95%, or even at least 98%) gas exchange properties.

Once in use, the gas-permeable element may be regulating atmospheric conditions in a packaging or medical device comprising the gas-permeable element in fluid communication with a (one or more) functional substances, such as a drug, a nutraceutical (e.g., vitamins or probiotics), a diagnostic reagent, herbal products (cannabis), and the gas-permeable element provides stabilization and/or extend the shelf life of one or several functional substances in the packaging or the medical device.

The gas-permeable element (being, e.g., a canister, a stopper, or a compartment of a packaging or a medical device) may comprise an active structure formed from a mixture including particles of an active material and a fibrillated polymer as a binder. The fibrillated polymer may be a polymer to which shear has been applied. The fibrillated polymer may hold the active material by entanglement.

The applying of shear may lead to a resulting fibrillation involving the formation of fibrils (material strings) during the mixing under shear. The particles of active material may then be held by these strings, i.e., the particles may be nested within a web of fibrils formed (e.g., during a milling step for applying shear).

The active material may be at least one element selected from the following group: a desiccant, a volatile organic chemical absorber, an odor absorber, an odor emitter, an oxygen absorber, and a humectant.

The active material may be activated carbon and/or silica gel and/or zeolite and/or any substance with an ability to exchange a gaseous substance with the headspace of the packaging or device to be regulated.

Moreover, the gas-permeable element may comprise a molded thermoplastic gas-permeable envelope surrounding the active structure such that the active structure is in fluid communication with the atmosphere of a packaging or a medical device in which the gas-permeable element is placed. The molded thermoplastic gas-permeable envelope may, for example, be an injection molded component or a thermoformed component.

The gas-permeable envelope surrounding the active structure may advantageously be a molded envelope made of a monolithic thermoplastic material. In other words, each wall of the gas-permeable envelope may advantageously be a homogeneous structure, rather than an assembly of discrete elements as is the case, e.g., of polymeric non-wovens.

The active material may comprise one or several active substances capable of adsorbing various different pollutants such as humidity, oxygen, odor and/or other possible pollutants. They may belong to a group of humidity adsorbers, oxygen scavengers, odor adsorbers and/or emitters of humidity or volatile olfactory organic compounds. Optionally, the active substance can also be capable of releasing gaseous substances such as moisture or aroma. Such a property can, for example, be useful for applications where sensitive products to be stored require a certain humidity level. Such products are, for example, powders, or herbal products.

The active material may comprise one or several dehydrating agents, e.g., selected from a group comprising silica gels, dehydrating clays, activated alumina, calcium oxide, barium oxide, natural or synthetic zeolites, molecular or similar sieves, or deliquescent salts such as magnesium sulfide, calcium chloride, aluminum chloride, lithium chloride, calcium bromide, zinc chloride or the like. Optionally, the dehydrating agent is a molecular sieve and/or a silica gel.

A suitable oxygen collecting agent may be selected from a group comprising metal powders having a reducing capacity, in particular iron, zinc, tin powders, metal oxides still having the ability to oxidize, in particular ferrous oxide, as well as compounds of iron such as carbides, carbonyls, hydroxides, used alone or in the presence of an activator such as hydroxides, carbonates, sulfites, thiosulfates, phosphates, organic acid salts, or hydrogen salts of alkaline metals or alkaline earth metals, activated carbon, activated alumina or activated clays. Other agents for collecting oxygen can also be chosen from specific reactive polymers such as those described for example in the patent documents U.S. Pat. No. 5,736,616 A, WO 99/48963 A2, WO 98/51758 A1 and WO 2018/149778 A1. In a variant, the oxygen collecting agent may comprise an organic oxygen absorbent selected from at least one of unsaturated fatty acid compounds and chain hydrocarbon polymers having an unsaturated group.

As the molded thermoplastic gas-permeable envelope surrounds the active structure, contamination of, e.g., a space in the packaging or medical device that is in fluid communication with the active structure may be prevented by the shielding effect of the envelope. As the envelope is gas-permeable, a fluid communication takes place between where the active structure is provided and an atmosphere of the packaging or the medical device. The mentioned atmosphere may be the only atmosphere or just one or several of two or more of (similar, identical, or different) atmospheres of the packaging or the medical device. The latter means that there may also be several different inside spaces in the medical device or packaging, wherein one or several of these spaces may be in fluid communication with the active structure.

The surrounding of the active structure by the molded thermoplastic gas-permeable envelope such that the active structure is in fluid communication with the atmosphere of a packaging or a medical device in which the gas-permeable element is placed may be realized by providing the active structure at an exposed position in the gas-permeable element, while “exposed” is to be understood as a provision to be exposed to fluid communication with an outside surrounding the gas-permeable element, and/or exposed towards a part of the gas-permeable element that is oriented towards an inside (an atmosphere) in the packaging or medical device, when the gas-permeable element is fully or partially placed on/in the packaging or medical device.

In the case of a stopper, the structural configuration to expose the active structure may, in particular, be understood to express that the active structure and the surrounding envelope are provided on the side of the stopper that is exposed towards the inside of the packaging or device in/on which the stopper is placed.

As shear has been applied to the polymer and the polymer is, hence, a fibrillated polymer, the particles of an active material may be held by entanglement (rather than being coated on the polymer, for example). In other words, for example, carbon and/or silica gel and/or zeolite may be held by the fibrillated polymer as a binder by entanglement. This may prevent powder development and contamination with the particles of an active material outside of the gas-permeable element.

Moreover, due to the shearing and the resulting entanglement of the active material particles and the polymer, the amount of active material relative to the polymer may be increased when compared to alternative modes of entrainment (such as, e.g., compounding).

Moreover, the mixture of the particles and the fibrillated polymer may increase the amount of active material that is accessible to a fluid (e.g., gas such as air) that is in fluid communication with the active structure. In particular, the entanglement between the particles and the binder may thus improve the atmosphere regulating effect of the gas-permeable element in a packaging or a medical device.

The location in the gas-permeable element where the active structure is provided, may face a part of the gas-permeable element configured to face an inside space of a packaging or a medical device in which the gas-permeable element is partially or fully configured to be provided/placed.

The mixture of the particles of an active material and the polymer of the active structure may comprise between 80% and 99% particles of an active material and between 1% and 20% of polymer by weight. The sum of the active material and the polymer may constitute at least 90%, or 95%, or even 100% (up to technically unavoidable residues) of a total of the mixture by weight. A mixture of the described type may particularly promote an atmosphere regulating effect in a packaging or a medical device.

The sum of the active material and the polymer may constitute at least 95% of a total of the mixture by weight. The remaining up to 5% of the mixture by weight may be a rest (involving, e.g., residues/impurities). The sum may even constitute 98%, 99% or a higher amount by weight. The rest may be a minimum in terms of impurities/residues that cannot be avoided for technical reasons and/or additives such as processing aids (e.g., lubricants facilitating the distribution of active particles in a fibrillated matrix).

Covering the active structure with a gas-permeable envelope may have the benefit of the amount of the polymer (such as, e.g., PTFE) in the active structure being reduced (i.e., having a higher ratio of active material to polymer), wherein mechanical stability is provided by the envelope and a higher friability of the active structure may be acceptable. Reducing the amount of polymer may in turn reduce the overall cost (because a polymer, such as PTFE, frequently is more expensive than an active material such as desiccant or activated carbon, etc.). Moreover, the high ratio between active material and polymer may reduce the halogen content of the polymer (e.g., polymer matrix), which may be important for halogen sensitive items or market applications.

The particles of active material of the active structure may have a particle size in a range of 5 μm to 30 μm, or even 5 μm to 20 μm. This may, especially in combination with entanglement between a binder (such as fibrillated polymer) and the particles, particularly promote a large surface exchange with air and, hence, an efficient/strong atmosphere regulating property. An average particle size may be around 10 μm, with less than 2 w/w % of particles having a weight greater than 20 μm.

However, depending on the selection of the active material, the particle sizes may also be selected to be bigger, e.g., in a range of 5 μm to 150 μm, or 5 μm to 120 μm, 5 μm to 100 μm, 5 μm to 80 μm, 5μm to 60 μm, 5 μm to 50 μm, 5 μm to 40 μm, or 5 μm to 30 μm.

The active structure may be an active sheet (i.e., a sheet-like structure).

A thickness of the active sheet may lie in a range of 0.2 mm to 10 mm (boundary points may be included). According to some embodiments, the thickness may be in a range of 0.25 mm to 5 mm, or 0.5 mm to 3 mm, or 1 mm to 2.5 mm. These increasingly narrower ranges may (to an increasing degree with increasingly narrower range) offer a particularly good compromise between space-efficiency (the active structure may in the case of using active carbon, e.g., have apparent densities of granular active carbon in a range of 0.4 to 0.6, and it may thus take about twice less space to have the same adsorption properties as with comparative materials) and strong atmosphere regulating property. Especially the combination of particle sizes in the range of 5 μm to 150 μm (and even more so: 5 μm to 30 μm) with these thickness ranges of the active sheet (o an increasing degree with increasingly narrower ranges) may offer an increasingly good compromise between the different properties of the active sheet and, hence, of the gas-permeable element as a whole.

The gas-permeable element may be a canister, with the gas-permeable envelope comprising one or several thermoplastic walls of the canister. One or several of these walls may comprise at least one ventilation hole or ventilation path for allowing a passage of a fluid (in particular, allowing air exchange).

The canister may be robust and very simple to dispose in a packaging or a medical device (also, e.g., as an add-on for “upgrading” the packaging's or the medical device's properties, even when already in use).

The canister may be manufactured using a molding technique and may comprise one or several thermoplastic components (e.g.,. an outside wall, a body of the canister, etc.).

According to some embodiments, a part of the gas-permeable envelope (which may be a thermoplastic component of a canister such as a thermoplastic wall) is overmolded over the active structure.

One or several components of the gas-permeable element (e.g., a canister), and in particular the gas-permeable envelope, may be made of a suitable plastic material that may be selected from the group comprising radical or linear high and low density polyethylenes, copolymers of ethylene such as for example ethylene vinyl acetates, ethylene ethyl acrylates, ethylene butyl acrylates, ethylene maleic anhydrides, ethylene alpha olefines, regard-less of the methods of polymerization or modification by grafting, polypropylene and copolymers, polybutene-1, polyisobutylene. Polyolefins may be selected to make the canister for cost reasons and because they are easy to use.

Other polymer materials may be also be used, such as polyvinyl chloride, copolymers of vinyl chloride, polyvinylidene chlorides, polystyrenes, copolymers of styrene, derivatives of cellulose, polyamides, polycarbonates, polyoxymethylenes, polyethylene terephthalates, polybutylene terephthalates, copolyesters, polyphenylene oxides, polymethyl methacrylates, copolymers of acrylate, fluoride polymers, polyphenylene sulphides, polyarylsulphones, polyaryletherketones, polyetherimides, polyimides, polyurethanes, phenol resins, melamine resins, urea resins, epoxy resins and unsaturated polyester resins.

Biodegradable polymer materials, with for example a starch base, are also possible, such as polylactic acids (PLA).

Combinations of these polymers can be used, if desired. The polymer used to produce the canister can also contain one or more additives such as fibers, expanding agents, additives such as stabilizers and colorants, sliding agents, demolding agents, adhesion agents or reinforced catching agents and/or any others according to the requirements of usage.

The gas-permeable element may be a canister, a stopper, or a compartment in a packaging or a medical device. In each of these cases, the gas-permeable envelope surrounding the active structure may comprise one or several thermoplastic components such as one or several thermoplastic walls with at least one ventilation hole for allowing a passage of a fluid (in particular, air exchange). The at least one ventilation hole may be covered by a porous membrane.

The membrane may comprise or consist of a textile or fabric comprising polymer fibers, woven or non-woven, or a perforated polymer film. Examples of polymer fabrics that may be used for the or each membrane portion include non-woven fabrics based on polyethylene or polypropylene fibers. In particular, suitable materials include the products sold by DUPONT under the trademark TYVEK®, which are spun-bonded non-woven fabrics comprising polyethylene fibers, in particular based on high-density polyethylene (HDPE) fibers. Examples of perforated polymer films that may be used include perforated films of polyethylene or polypropylene.

At least a part of the gas-permeable envelope may be overmolded over the active structure. For example, the gas-permeable element may be a canister, and the gas-permeable envelope may include a thermoplastic wall of the canister that is overmolded over an active structure.

The gas-permeable element may be a card (i.e., a card-shaped canister). A card may be conveniently placed in a packaging or a medical device, and the card may be (at least in part) flexible or rigid, depending on the desired use of the card.

According to some embodiments of the gas-permeable element, the fibrillated polymer holds the active material by entanglement. This may increase the effectiveness of the atmosphere regulating property in a packaging or a medical device, as the holding by entanglement may increase the amount of fluid exchange between the active material of the active structure and the surrounding (as compared to other techniques of holding an active material in or on another type of binder, in particular a non-fibrillated binder). Due to the fibrillated structure of the binder, and its low proportion relative to the active material, the impact of the fibrillated binder on fluid (gas) exchange between the active material and the atmosphere to be regulated is limited. This is different from a non-fibrillated binder, as is the case in a desiccant entrained polymer, where the gas diffusion properties of the polymer resin may have an impact on fluid (gas) exchange between the active material and the atmosphere to be regulated. Advantageously, a fibrillated polymer can be used as a binder for any active material.

According to some embodiments of the gas-permeable element, the gas-permeable envelope comprises in its inner volume, on the one hand, particles of active material held by entanglement in the active structure and, on the other hand, particles of active material received in the remaining volume inside of the envelope, e.g. in bulk, apart from the active structure. For example, particles of a first type of active material may be held by entanglement in the active structure, whereas particles of a second type of active material may be received in the remaining volume inside of the envelope, e.g. in bulk, apart from the active structure.

According to some embodiments of the gas-permeable element, the gas-permeable envelope comprises at least one perforation for air exchange between the inside and the outside of the envelope, and the active structure is arranged in the envelope in such a way as to cover the at least one perforation. In this case, the active structure is advantageously gas permeable so that a gas passing through the at least one perforation of the envelope can interact not only with particles of active material held by entanglement in the active structure, but also with other particles of active material received in the remaining volume inside of the envelope, e.g. in bulk, apart from the active structure.

The present disclosure also relates to packaging or medical device filled with sensitive and/or odorous products, such as food, nutraceutical products, pharmaceutical products, herbal products and/or diagnostic products. The packaging or medical device comprises a gas-permeable element in accordance with any one of the embodiments or aspects described above, or in accordance with a combination of embodiments of aspects (in so far not contradictory with one another).

In particular, the packaging or medical device may comprise at least one of the items selected from the following list: a canister, a stopper, and a compartment, wherein each item may be in accordance with any one of the embodiments or aspects described above, or in accordance with any possible combination of embodiments of aspects (in so far not contradictory with one another).

This disclosure also relates to a method of manufacturing a gas-permeable element, such as a canister, a stopper, or a compartment according to any one (or several) of the aspects/embodiments described above.

This disclosure relates, in particular, to a method of manufacturing a gas-permeable element, such as a canister, a stopper, or a compartment that may comprise the steps of:
providing a mixture of particles of an active material, such as a desiccant, a volatile organic chemical absorber, an odor absorber or emitter, an oxygen absorber, or a humectant (and, in particular, such as carbon and/or silica gel and/or zeolite), and a dispersion comprising a polymer, such as polytetrafluoroethylene (PTFE);
fibrillating the polymer by applying shear thereto, in particular by adding the mixture to a mill or a mixer, so as to form an active structure in which the fibrillated polymer holds the active material by entanglement, the active structure optionally being in the form of an active sheet;
associating a portion of the active structure with a molded thermoplastic gas-permeable envelope so that the gas-permeable envelope surrounds the active structure.

The resulting gas-permeable element may have benefits as described for the respective embodiment/aspects of the elements described above.

The fibrillating of the mixture in a mill or a mixer by applying shear thereto is to be distinguished from applying shear stress by compounding (e.g., mixing a resin and a mixture at a particular temperature while applying shear stress). In the case of the method's fibrillation step, fibers are formed during the mixing. Active particles may, as a result, be held by the formed fibers (strings), i.e., the particles are then nested within a web of fibrils formed during the milling step. The latter implies that there is then entanglement between the particles and the polymer (such as PTFE).

The milling may also involve some level of heating. The mill itself may be heated to a temperature above 30° C., e.g., to a range of 30° C. to 120° C., optionally 50° C. to 120° C.

The molded thermoplastic gas-permeable envelope may be formed by any technique known in the art, e.g., by injection molding, thermoforming, extruding, injection or extrusion blow-molding, rotational molding, or any combination thereof. The method may comprise the step of molding the gas-permeable envelope.

According to some embodiments of the method, the portion of the active structure may be associated with a canister body or cap, being at least a part of a gas-permeable envelope of a canister, e.g., by inserting the portion of the active structure in a part of the canister body or cap, or by molding a part of the canister body or cap over the portion of the active structure.

According to some embodiments of the method, the portion of the active structure may be associated with a stopper body, being at least a part of a gas-permeable envelope of a stopper, e.g., by inserting the portion of the active structure in a part of the stopper body or by molding a part of the stopper body over the portion of the active structure.

According to some embodiments of the method, the portion of the active structure may be associated with a compartment body, being at least a part of a gas-permeable envelope of a compartment in a packaging or a medical device, e.g., by inserting the portion of the active structure in a part of the compartment body or by molding a part of the compartment body over the portion of the active structure.

In accordance with any aspect/embodiment, the mixture may be fibrillated during any one of a mixing step, a fibrillation step, a forming step, or a combination of any two or all three of these steps.

The mixture may be fibrillated in a mill, wherein shear fibrillates the polymer. For example, a rotating mill may be used.

The fibrillated mixture may be formed directly in the form of an active sheet in a single pass through a mill.

The method may comprise a step of calendaring to increase a density and/or reduce a thickness of the active sheet.

This disclosure also relates to a gas-permeable element that is manufactured in accordance with one or several embodiment or aspects of any one or several of the methods in accordance with the present disclosure described above.

Moreover, this disclosure also relates to use of an active sheet for providing an atmosphere regulation property to a gas-permeable element having a molded thermoplastic gas-permeable envelope, such as a canister, a stopper, or a compartment, for being formed or at least partially placed in a packaging or medical device filled with sensitive and/or odorous products, said active sheet formed from a mixture including particles of an active material, such as a desiccant, a volatile organic chemical absorber, an odor absorber or emitter, an oxygen absorber, or a humectant (in particular, such as activated carbon and/or silica gel and/or zeolite and/or an oxygen scavenger and/or a gas releasing material); and a fibrillated polymer as a binder, the fibrillated polymer being a polymer to which shear has been applied, the fibrillated polymer holding the active material by entanglement. This may provide the additional property of atmosphere regulation to an existing packaging or a medical device or may be a convenient way of providing a new packaging or a medical device with this property.

Additional advantages and features of the present disclosure, that can be realized on their own or in combination with one or several features discussed above, insofar as the features do not contradict each other, will become apparent from the following description of particular embodiments.

### BRIEF DESCRIPTION OF THE DRAWINGS

For a better understanding of the present disclosure and to show how the same may be carried into effect, reference will now be made, by way of example only, to the accompanying drawings, in which:

The description is given with reference to the accompanying drawings, in which:

FIG. 1 is a perspective view of an embodiment of a canister for atmosphere control in accordance with this disclosure;

FIG. 2 is a cross sectional view along plane I-I in FIG. 1;

FIG. 3 is a cross sectional view of an embodiment of a canister in accordance with the present disclosure;

FIG. 4 is a cross sectional view of an embodiment of a canister in accordance with the present disclosure;

FIG. 5 is a cross sectional view of an embodiment of a compartment in a packaging in accordance with the present disclosure;

FIG. 6 is a perspective view of an embodiment of a stopper for atmosphere control in accordance with the present disclosure;

FIG. 7 is a cross sectional view along plane II-II in FIG. 6;

FIG. 8 is a cross sectional view of an embodiment of a stopper for atmosphere control in accordance with the present disclosure;

FIG. 9 is a perspective view of an embodiment of a card-shaped canister for atmosphere control in accordance with the present disclosure;

FIG. 10 is a cross sectional view of the card along plane III in FIG. 9.

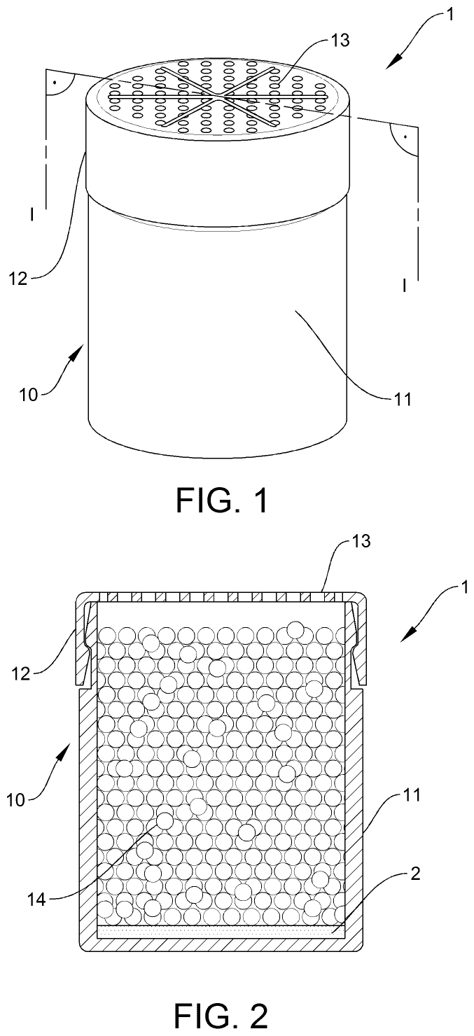

FIG. 1 is a perspective view of an embodiment of a canister 10 for atmosphere control in accordance with this disclosure.

The canister 10 of FIG. 1 is an example of a gas-permeable element 1 in accordance with the present disclosure. The canister 10 is for being placed in a packaging or medical device filled with sensitive and/or odorous products and for regulating an atmosphere in the packaging or medical device.

The canister 10 comprises a body 11 molded of thermoplastic material as well as a cap 12 that is also molded of thermoplastic material.

FIG. 2 is a cross sectional view along plane I-I in FIG. 1. As shown by this view, the cap 12 is clipped onto the body 11 to close the canister 10. The cap 12 is provided with a plurality of perforations 13 that allow for air exchange between inside and outside of the canister 10, so that the latter can exert an atmosphere regulating function in a packaging or medical device in which the canister 10 is placed.

An active structure 2 is placed, e.g. by being punched, into the bottom of the canister 10. Most of the remaining volume inside of the canister 10 (aside of the volume that is occupied by the active structure 2) is, in the case of the embodiment of FIG. 1, filled with silica gel particles 14 (or, in the case of another embodiment, with molecular sieve particles).

The active structure 2 of FIG. 2 is formed of a mixture including particles of activated carbon and a fibrillated polymer as a binder (a PTFE matrix). Shear has been applied to the PTFE matrix, and the activated carbon particles are held in the PTFE matrix by entanglement.

The canister 10 comprising the body 11 and the gas-permeable cap 12 is an example of a gas-permeable envelope (in the sense of this disclosure) surrounding the active structure 2. The active structure 2 remains in fluid communication with the outside of the canister 10 by virtue of air exchange through the perforations 13 of the cap 12.

If the canister 10 is placed in a packaging or a medical device, the active carbon particles thus exert an atmosphere regulating effect. As the active carbon particles are entangled with the PTFE matrix, no powder contamination with carbon particles occurs in the packaging and/or medical device. Moreover, the entangled binding increases the amount of air exchange that takes place with the carbon particles, thus increasing the atmosphere regulating effect. Friction of the active carbon particles with neighboring active carbon and desiccant particles is also reduced, as the active carbon particles are maintained entangled in the fibrillated PTFE matrix. In addition, the monolithic molded thermoplastic gas-permeable envelope surrounding the active structure protects the friable active structure from deformation which may result in friction between particles of active material held by entanglement in the fibrillated polymer and may thus generate small dust particles. This is particularly advantageous when active carbon is part of the active material of the active structure, as active carbon is very friable and liable to break down into small dust particles.

While the active sheet 2 of the embodiment of the canister 10 of FIG. 1 is pressed into the bottom of the body 11, the canister of another embodiment may be overmolded onto the active sheet (in accordance with some embodiments, the cap 12 is overmolded over the active sheet).

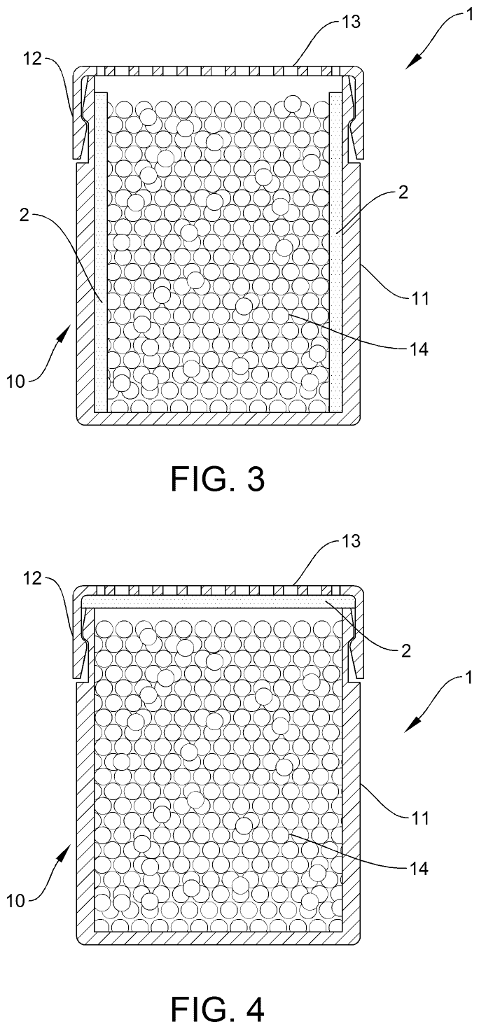

FIG. 3 depicts a cross sectional view of an embodiment of a canister 10 in accordance with the present disclosure. The canister 10 of FIG. 3 is another example of a gas-permeable element 1 in accordance with the present disclosure.

The embodiment of FIG. 3 may be considered similar to the embodiment of FIG. 2. The difference is that the active structure 2 is provided at a different position. It is namely placed against the (inside) side wall of the body 11, e.g. in the form of a roll, rather than against the bottom of the body 11. In the case of this embodiment, the active structure 10 (in the form of a sheet) extends around the entire inner circumference of the side wall of the body 11. In the case of other embodiments, the active structure 2 may extend over only a part of the inner side wall.

The other features of the embodiment of FIG. 3 are analogous to those of the embodiment of FIG. 2 and are denoted by like numerals. The description of those features will not be repeated.

FIG. 4 depicts a cross sectional view of an embodiment of a canister in accordance with the present disclosure. The canister 10 of FIG. 4 is another example of a gas-permeable element 1 in accordance with the present disclosure. The difference is that the active structure 2 is provided at a different position than in the cases of FIGS. 2 and 3. The active structure 2 is, in the case of the embodiment of FIG. 4, placed against the inner wall of the cap 12, rather than against a part of the body 11. In this example, the active structure 2 may advantageously be placed against the inner wall of the cap 12 before the cap 12, having the active structure 2 placed therein, is clipped onto the body 11 to close the canister 10. It is also understood that, in another embodiment, the perforations 13 of the cap 12 may be replaced by perforations in the bottom of the body 11.

In the embodiment shown in FIG. 4, the active structure 2 covers the perforations 13 of the cap 12. This arrangement has the advantage that the active structure 2 forms a barrier to the escape of small dust particles that may result either from the active material entangled in the active structure 2, or from the other active material 14 received in bulk in the remaining volume inside of the canister 10 (i.e. aside of the volume that is occupied by the active structure 2). Of course, the active structure 2 is gas permeable so that the gas passing through the perforations 13 of the cap 12 can interact not only with the active material entangled in the active structure 2, but also with the other active material 14 received in bulk in the remaining volume inside of the canister 10.

The other features of the embodiment of FIG. 4 are analogous to those of the embodiments of FIGS. 2 and 3 and are denoted by like numerals. The description of those features will not be repeated.

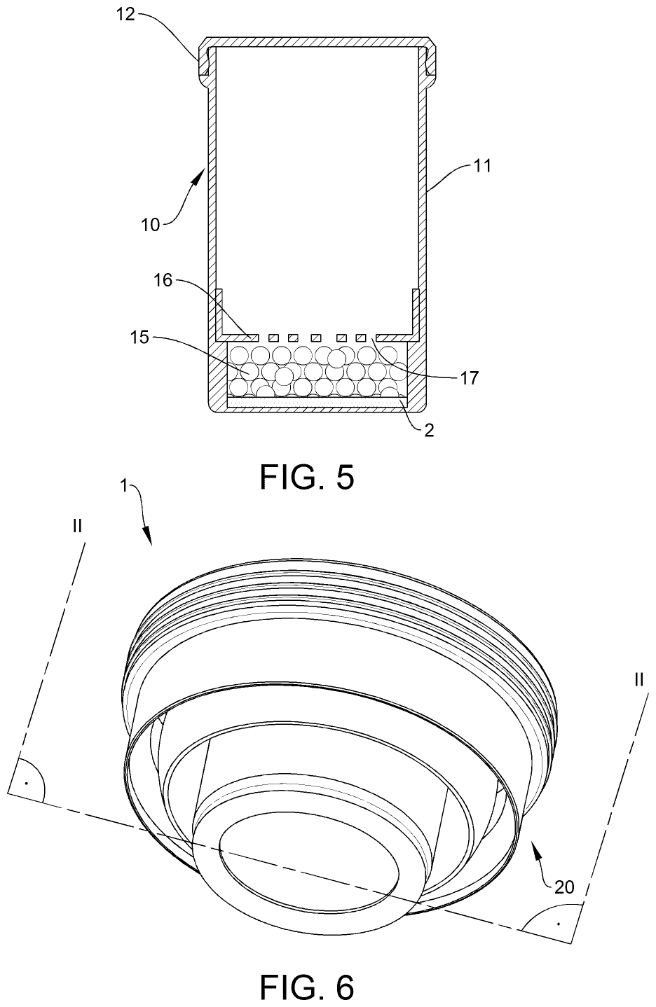

FIG. 5 depicts a cross sectional view of an embodiment of a compartment 15 formed in a packaging in accordance with the present disclosure. The compartment 15 of FIG. 5 is another example of a gas-permeable element in accordance with the present disclosure.

The compartment 15 is delimited in the bottom of a moisture-proof packaging 10, including a tubular body 11 and a lid 12 for hermetically closing the tubular body 11. A gas-permeable insert 16 is attached inside the tubular body 11 and delimits two compartments located on both sides of the insert 16, including the compartment 15 for an active material on one side and a fillable tank for sensitive products on the other side. The sensitive products may be, e.g. pharmaceutical products, diagnostic products, etc.

Each one of the tubular body 11 and the insert 16 is molded of thermoplastic material. The insert 16 is provided with a plurality of perforations 17 that allow for air exchange between inside and outside of the compartment 15, so that the latter can exert an atmosphere regulating function in the fillable tank delimited above the insert 16.

An active structure 2 in the form of a sheet is placed, e.g. by being punched, into the bottom of the compartment 15. Most of the remainder of the compartment 15 is filled with silica gel particles 14 (or, in the case of another embodiment, with molecular sieve particles).

Here again, the active structure 2 of FIG. 5 is formed of a mixture including particles of activated carbon and a fibrillated polymer as a binder (a PTFE matrix). Shear has been applied to the PTFE matrix, and the activated carbon particles are held in the PTFE matrix by entanglement.

The compartment 15 comprising the bottom part of the tubular body 11 and the gas-permeable insert 16 is an example of a gas-permeable envelope (in the sense of this disclosure) surrounding the active structure 2. The active structure 2 remains in fluid communication with the outside of the compartment 15 by virtue of air exchange through the perforations 17 of the insert 16.

FIG. 6 is a perspective view of an embodiment of a stopper 20 for atmosphere control in accordance with the present disclosure. The stopper 20 of FIG. 6 is another example of a gas-permeable element 1 in accordance with the present disclosure.

The stopper 20 of FIG. 6 is for closing a packaging filled with sensitive and/or odorous products and for regulating an atmosphere in the packaging.

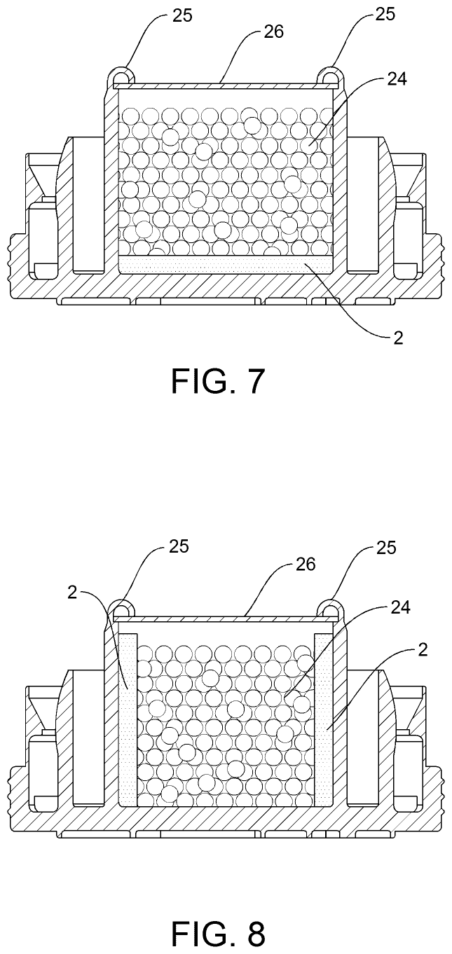

FIG. 7 is a cross sectional view along plane II-II in FIG. 6. The stopper 20 comprises an active structure 2 that has been placed, e.g. by being punched, against the upper inner surface of a cavity delimited by the stopper 20. The active structure 2 is a sheet made of a mixture of active carbon particles and a PTFE matrix as a binder. Shear has been applied to the PTFE matrix, and the active carbon particles are held in the PTFE matrix by entanglement. Most of a remainder of the inner cavity of the stopper 20 (the remainder with respect to the space occupied by the active structure 2) is filled with desiccant particles 24.

The side walls of the cavity of the stopper 20 comprise end portions 25 which are thinner than the remainder of the cavity side walls and are crimped to hold a piece of gas-permeable cardboard 26. The cavity delimited in the inner volume of the stopper 20 and closed by the gas-permeable cardboard 26 is an example of a gas-permeable envelope (in the sense of this disclosure) surrounding the active structure 2. The active structure 2 is in fluid communication with the atmosphere of a packaging on which is hermetically closed by the stopper 20. The stopper 20 in this state also partially projects into the packaging and is in this sense (partially) placed in the packaging.

FIG. 8 is a cross sectional of an embodiment of a stopper 20 for atmosphere control in accordance with the present disclosure. The stopper 20 of FIG. 8 is another example of a gas-permeable element 1 in accordance with the present disclosure.

The difference with respect to the embodiment of FIG. 7 is that the active structure 2 is provided at a different position than in the case of the embodiment of FIG. 7. The active structure 2 is, in the case of the embodiment of FIG. 8, placed, e.g. in the form of a roll, against the inner side wall of the cavity inside of the stopper 20.

The other features of the embodiment of FIG. 8 are analogous to those of the embodiment of FIGS. 7 and are denoted by like numerals. The description of these features will not be repeated.

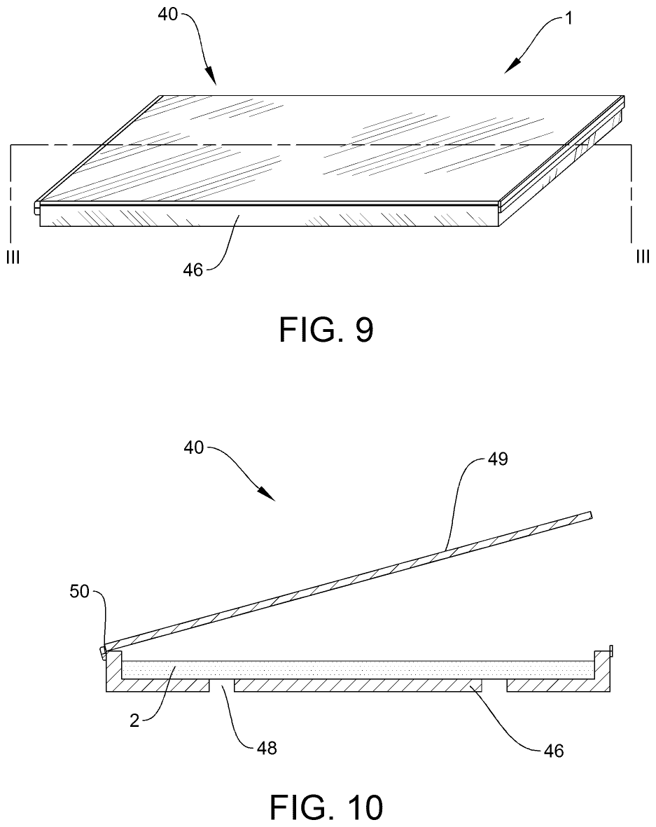

FIG. 9 is a perspective view of an embodiment of a card 40 for atmosphere control in accordance with the present disclosure. The card 40 of FIG. 9 is an example of a flat canister, i.e., another example of an embodiment of a gas-permeable element 1 in accordance with the present disclosure. FIG. 10 is a cross sectional view of the card along plane III-III in FIG. 9.

The card 40 in accordance with this embodiment comprises a rigid thermoplastic support 46. However, cards in accordance with other embodiments may, as an alternative, comprise flexible supports (e.g., flexible thermoplastic supports).

The rigid thermoplastic support 46 is overmolded over an active structure 2 (in the form of a portion of an active sheet with the shape of a parallepiped). The support 46 is provided with perforations 48 allowing for air exchange between a surrounding atmosphere and the active structure 2.

The active structure 2 of FIGS. 9 and 10 is formed of a mixture including, on the one hand, an active material comprising both particles of activated carbon and particles of silica gel and, on the other hand, a fibrillated polymer as a binder (a PTFE matrix). Shear has been applied to the PTFE matrix, and the particles of activated carbon and particles of silica gel are held in the PTFE matrix by entanglement.

Moreover, the embodiment of FIG. 9 is provided with a cover 49 that is molded together with the remainder of the support 46 and, specifically, linked therewith via a film hinge 50. A clipping means 51 is provided to lock the cover 49 on the remainder of the support 46 in the closed position. Thus, using the combination of support 46 and cover 49, the active structure 2 can be completely closed inside of the casing and is, hence, fully surrounded (leaving only the perforations 48 for air exchange).

The card 40 comprising the gas-permeable support 46 and the cover 49 is an example of a gas-permeable envelope (in the sense of this disclosure) surrounding the active structure 2. The active structure 2 remains in fluid communication with the outside of the card 40 by virtue of air exchange through the perforations 48 of the support 46.

It will be apparent to those skilled in the art that various modifications and variations can be made in the disclosed devices and systems without departing from the scope of the disclosure. Other aspects of the disclosure will be apparent to those skilled in the art from consideration of the specification and practice of the features disclosed herein. It is intended that the specification and examples be considered as exemplary only. Many additional variations and modifications are possible and are understood to fall within the framework of the disclosure.

1. A gas-permeable element at least partially placed in a packaging or medical device for regulating an atmosphere in the packaging or medical device,
wherein the gas-permeable element comprises:
an active structure formed from a mixture including particles of an active material and a fibrillated polymer as a binder, wherein the fibrillated polymer is a polymer to which shear has been applied and wherein the fibrillated polymer holds the active material by entanglement; and
a molded thermoplastic gas-permeable envelope surrounding the active structure such that the active structure is in fluid communication with the atmosphere of the packaging or medical device in which the gas-permeable element is placed.

2. The gas-permeable element of claim 1, wherein the gas-permeable envelope comprises in its inner volume particles of active material held by entanglement in the active structure and particles of active material in a remaining volume inside of the envelope apart from the active structure.

3. The gas-permeable element of claim 1, wherein the gas permeable envelope contains at least one perforation for air exchange between an inside and an outside of the envelope, wherein active structure is arranged in the envelope to cover the at least one perforation.

4. The gas-permeable element of claim 3, wherein the active structure is gas permeable so that a gas passing through the at least one perforation of the envelope can interact not only with particles of active material held by entanglement in the active structure, but also with other particles of active material in the remaining volume inside of the envelope apart from the active structure.

5. The gas-permeable element of claim 1, wherein the mixture of the particles of the active material and the polymer of the active structure comprises between 80% and 99% particles of the active material and between 1% and 20% of polymer by weight, wherein a sum of the active material and the polymer comprises at least 90% of a total of the mixture by weight.

6. The gas-permeable element of claim 1, wherein the particles of active material of the active structure have a particle size in a range of 5 μm to 30 μm.

7. The gas-permeable element of claim 1, wherein the active structure comprises an active sheet, with a thickness in a range of 0.2 mm to 10 mm.

8. The gas-permeable element of claim 1, wherein the gas-permeable envelope surrounding the active structure comprises a molded envelope comprising a monolithic thermoplastic material.

9. The gas-permeable element of claim 1, wherein the gas-permeable envelope surrounding the active structure comprises thermoplastic walls with at least one ventilation hole or ventilation path for allowing a passage of a fluid.

10. The gas-permeable element of claim 9, wherein a part of the gas-permeable envelope is overmolded over the active structure.

11. A packaging or medical device comprising the gas-permeable element, according to claim 1.

12. A method of manufacturing the gas-permeable element of claim 1,
comprising:
providing a mixture of particles of an active material, and a dispersion comprising a polymer,
fibrillating the polymer by applying shear thereto to form an active structure in which the fibrillated polymer holds the active material by entanglement, and
associating a portion of the active structure with a molded thermoplastic gas-permeable envelope so that the gas-permeable envelope surrounds the active structure.

13. The method of claim 12, wherein the portion of the active structure is associated with a component selected from the group consisting of a canister body, a stopper body, and a compartment body.

14. The method of claim 13, wherein the step of associating is performed by inserting the portion of the active structure in a part of the component.

15. The method of claim 13, wherein the step of associating is performed by molding a part of the component over the portion of the active structure.

16. The method of claim 12, wherein the mixture is fibrillated during a step selected from the group consisting of a mixing step, a fibrillation step, a forming step, and a combination thereof.

17. The method of claim 12, wherein the mixture is fibrillated in a mill, wherein shear fibrillates the polymer.

18. The method of claim 12,
wherein a fibrillated mixture is formed directly in the form of an active sheet in a single pass through a mill.

19. (canceled)

20. The gas-permeable element of claim 1, wherein the active material is selected from the group consisting of a desiccant, a volatile organic chemical absorber, an odor absorber or emitter, an oxygen absorber, a humectant, and mixtures thereof.

21. The gas-permeable element of claim 9, wherein the at least one ventilation hole or path is covered by a porous membrane.
